(19) United States
(12) Patent Application Publication
(10) Pub. No.: US 2016/0136832 A1
(43) Pub. Date: May 19, 2016

(54) CUTTING TABLE WITH DIFFERENTIATED SUCTION FOR STABILISING THE MATERIAL TO BE CUT

(71) Applicant: ATOM S.P.A., Vigevano (PV) (IT)

(72) Inventors: Michele CANTELLA, Vigevano (PV) (IT); Ernesto MIRABELLO, Vigevano (PV) (IT)

(21) Appl. No.: 14/899,738

(22) PCT Filed: Jun. 16, 2014
(86) PCT No.: PCT/EP2014/001636

§ 371 Date: Dec. 18, 2015

(30) Foreign Application Priority Data
Jun. 18, 2013 (IT) MI2013A001002

(51) Int. Cl. B26D 7/01; C14B 5/00; D06H 7/00

(52) U.S. Cl. CPC B26D 7/018; D06H 7/00; C14B 5/00

(57) ABSTRACT

A cutting table (10) with differentiated suction for the stabilisation of the material (14) to be cut, comprises a surface having a planar extension divided into a plurality of sectors (12) and surmounted by a permeable cover (18) on which said material is laid, The cover (18) rests on an underlying rigid structure (20) provided with quadrangular indentations (22) corresponding to said sectors (12) along which two apertures are made (24-26) for the alternate suction of air at high and low pressure by means of respective pumps (34-34′). Each of said sectors (12) is divided into two zones respectively used for high and low pressure suction by means of the intervention of specific valve groups (50).

### CROSS REFERENCE TO RELATED APPLICATIONS

This application is a national phase of PCT application No. PCT/EP2014/001636, filed Jun. 16, 2014, which claims priority to IT patent application No. MI2013A001002, filed Jun. 18, 2013, all of which are incorporated herein by reference thereto.

### FIELD OF INVENTION

The present invention relates to a cutting table with differentiated suction for stabilising the material to be cut.

More in particular, the present invention relates to a cutting table for cutting skin, leather, fabrics, synthetic and foam materials even stratified, divided into sectors by means of air suction is performed to adequately stabilise the material during the cutting thereof, performed by one or more heads fitted with blades.

### BACKGROUND OF THE INVENTION

It is well known that to produce handicrafts in skin, leather and other materials so-called punching machines are used which may be of different types, i.e. with a swing arm, carriage or bridge. For the same function of cutting materials machines have been prepared equipped with a work surface particularly extended in length and in width, on which the material is placed in the form of leather, typically an irregular shape, or in the form of fabric or synthetic material in sheets or which wind off one or more bobbins. These machines, called cutting tables, comprise, according to a known type, a support transversally extending above the work surface with which at least one electronically moved operating head is combined; each head is provided with a blade which cuts and severs the material according to a pre-ordained pattern, sometimes projected onto the material itself placed on the work surface. Other cutting tables of smaller dimensions comprise an arm which extends to overhang the quadrilateral work surface and bearing the machining head; the arm may be parallel to one of the shorter sides of the work surface or one of the longer sides. The cuts performed on these cutting tables are clean and precise, but to achieve this result the material must be properly stabilised on the work surface, since otherwise it might curl and be dragged by the blade resulting in interruptions of the operating cycle and the creation of production waste. This drawback is especially manifest in the presence of material of reduced thickness and thus extremely light such as textiles, but even leather and the various synthetic materials may suffer localized curling or displacements due to the intervention thereon of the blades.

For this reason, cutting tables are traditionally provided with suction systems, extended along the work surface and activated over the entire area of said surface or only in certain areas. From Italian Patent no. 1,285,511 a method and the relative equipment for stabilising the material to be cut on the work surface of cutting tables is known. The solution provides that the latter is divided into a series of sectors distributed in a regular manner and provided with upwardly open cavities, each of which communicates with suction means; a valve is placed on the respective ducts, for example of the throttle type used to regulate, at least theoretically, the degree of vacuum also. The different areas are selectively activated as regards aspiration, which is done only for the sectors covered by the material. Globally, this solution is constructively complex and expensive, given the necessity of having to provide individual suction means with valves for each of the sectors which the work surface is divided into.

The patent EP 0 566817 also provides retaining the material lying on the work surface with a vacuum

The air vacuum application may be limited to predetermined areas of said surface and take place incrementally, starting from the central area towards the periphery of the part of material corresponding to the pieces to be obtained by cutting. This solution substantially presents the same drawbacks outlined above, relative to the fact of being complex and expensive.

A similar solution is implemented by the same applicant, which provides for the subdivision of the work surface into different areas which, however, are not connected to the individual suction means but to a common cavity in which a vacuum of air is created. In this case, the drawback is that of high losses of suction power, relative to the parts of the work surface not covered by the material.

### SUMMARY OF THE DISCLOSURE

The purpose of the present invention is to overcome the drawbacks complained of above.

More in particular, the purpose of the present invention is to provide a cutting table with suction in which the material lying on the work surface is subjected to a targeted and progressive suction effect along preordained areas at the moment of cutting.

Another purpose of the invention is to provide a cutting table as defined above suitable to perform a calibrated and constant aspiration avoiding giving rise to unnecessary energy consumption.

A further purpose of the invention is to make available to users a cutting table with suction suitable to ensure a high level of functionality over time, in addition such as to be easily and economically made.

These and other purposes are achieved by the cutting table of the present invention according to the main claim.

### BRIEF DESCRIPTION OF THE DRAWINGS

The construction and functional characteristics of the cutting table of the present invention will be more clearly comprehensible from the detailed description below in which reference is made to the appended drawings which show a preferred and non-limiting embodiment and wherein:

FIG. 1 shows schematically, seen from above, the work surface of the cutting table according to the invention, on which the material is placed, divided into the various areas to by the projection determined by the positioning software;

FIG. 2 is a schematic longitudinal cross-section of the same cutting, table, highlighting the suction circuits and relative operating means;

FIG. 3 schematically represents the cutting table divided into two independent suction chambers;

FIG. 4 schematically represents the same cutting table the surface of which is divided into a plurality of sectors on each of which the suction effect intervenes;

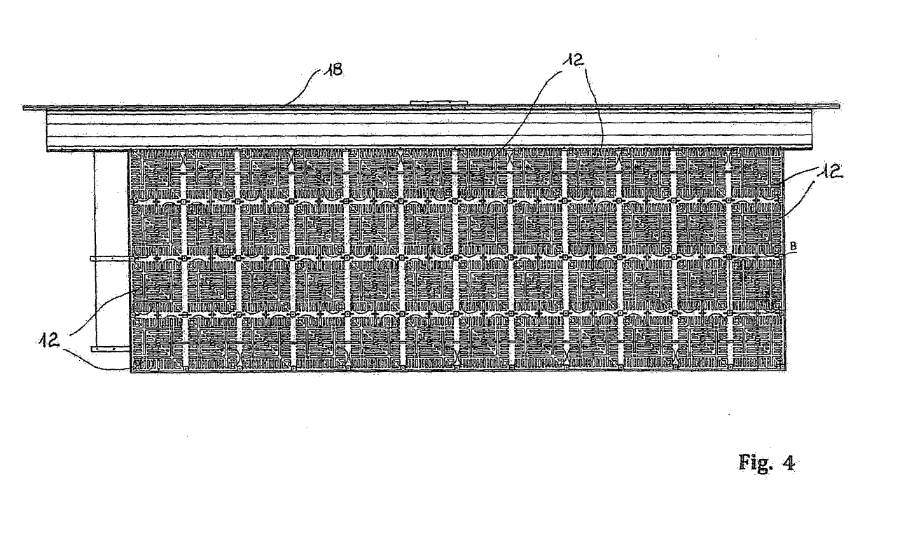

FIG. 5 schematically represents, in a view from above one of said sectors of the cutting table on which the aspiration takes place, particularly the sector designated as detail “B” in FIG. 4;

FIG. 6 is a schematic perspective view of the cutting table, with a partial cross-section illustrating the overall structure;

FIG. 7 is an enlargement of FIG. 5;

FIG. 8 schematically illustrates, in an exploded view, part of the cutting table along the area corresponding to the enlargement of FIG. 6.

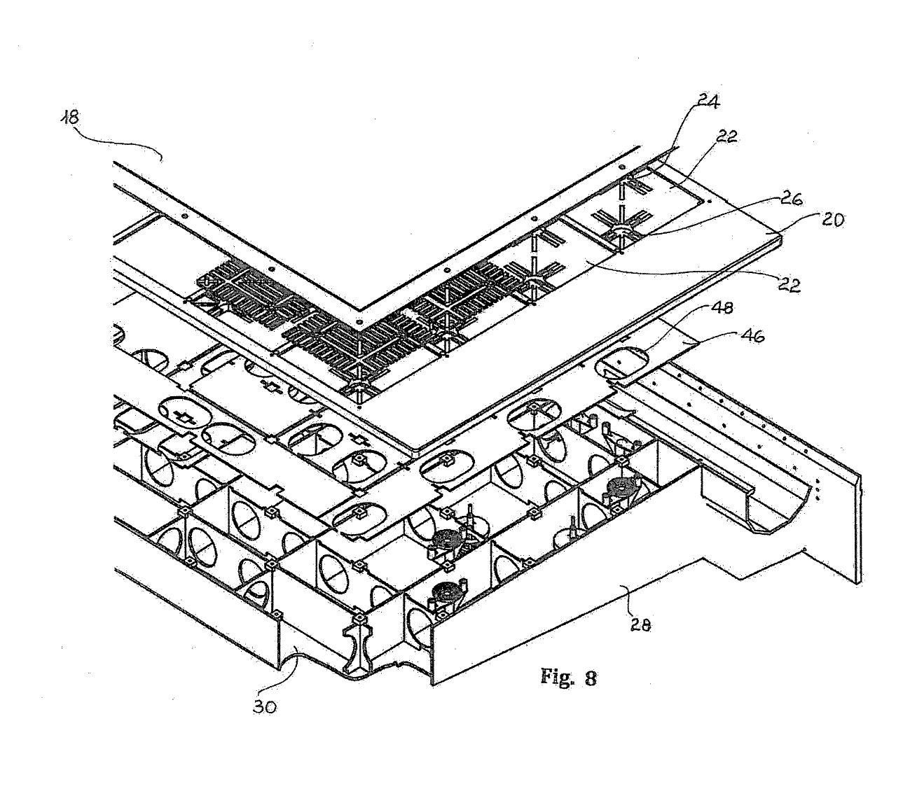

### DETAILED DESCRIPTION OF THE INVENTION

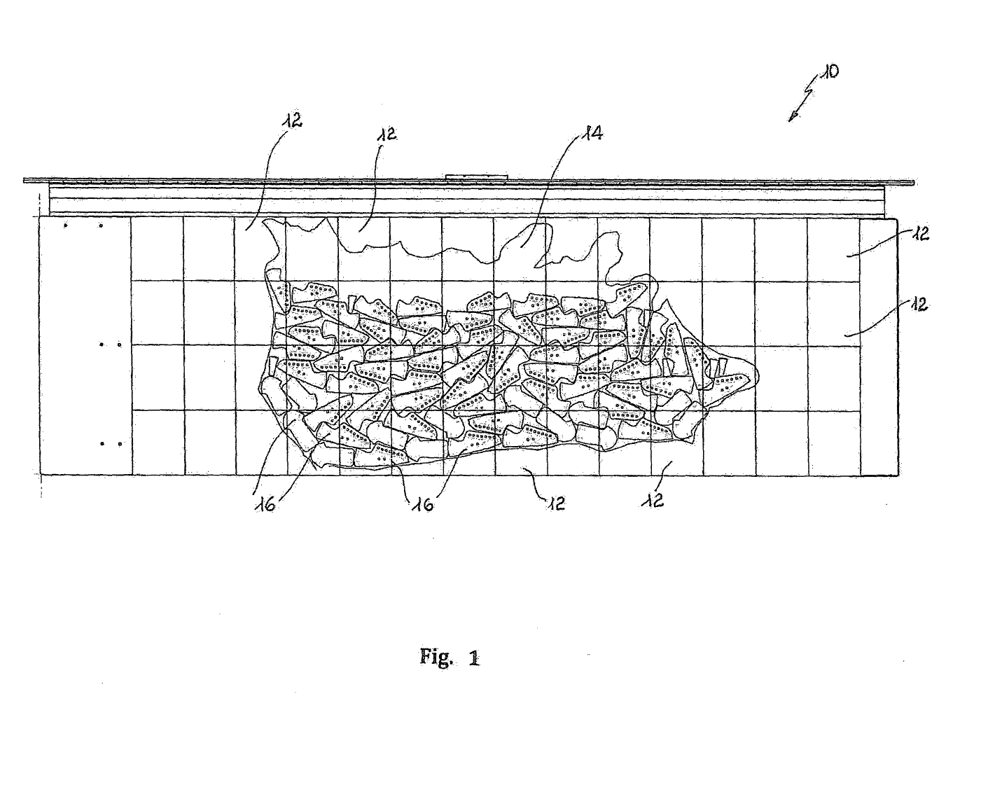

With initial reference to FIG. 1, the cutting table of the present invention is globally denoted by reference numeral 10 and defines a surface with a planar extension divided into a plurality of sectors 12, typically but not essentially of a square shape. The 12 sectors may be identical to each other or present different extension/configuration especially in some areas of the cutting table.

The material to be cut 14 typically leather of an irregular shape which t surmounts said sectors 12 partially entirely and partially only along more or less extensive areas is arranged on said surface. The same FIG. 1 shows, by way of example, the division of the material 14 into a variety of shapes 16, corresponding to the pieces to be obtained by means of the various cuts; such division, which optimises the use of the material minimising the scrap, is programmed by means of a specific programme, defined positioning software, by means of which said shapes variously oriented, not necessarily of the same shape, are projected onto the material itself. In some cases the projection of the shapes on the material does not take place, as is the case for example for synthetic materials, but the shape to be obtained is in any case already stored in the software guiding the cutting. In the embodiment example as per the figures, the cutting table 10 is designed to be surmounted by a known girder extending transversally (not shown), bearing one or more cutting heads which act on the material 14 and progressively cut it following the outlines of the various shapes 16.

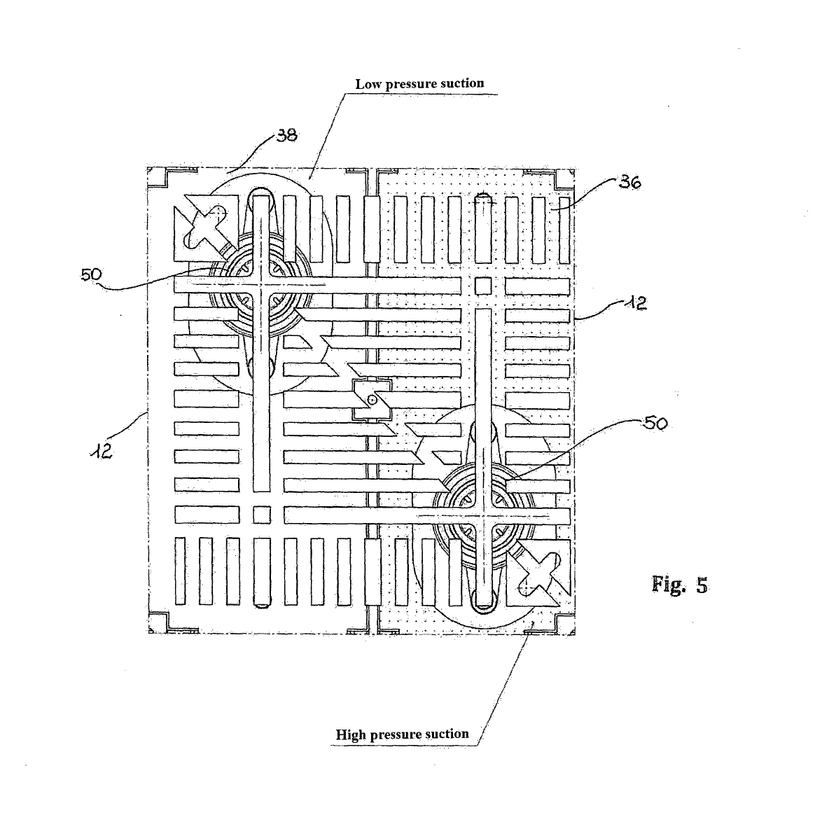

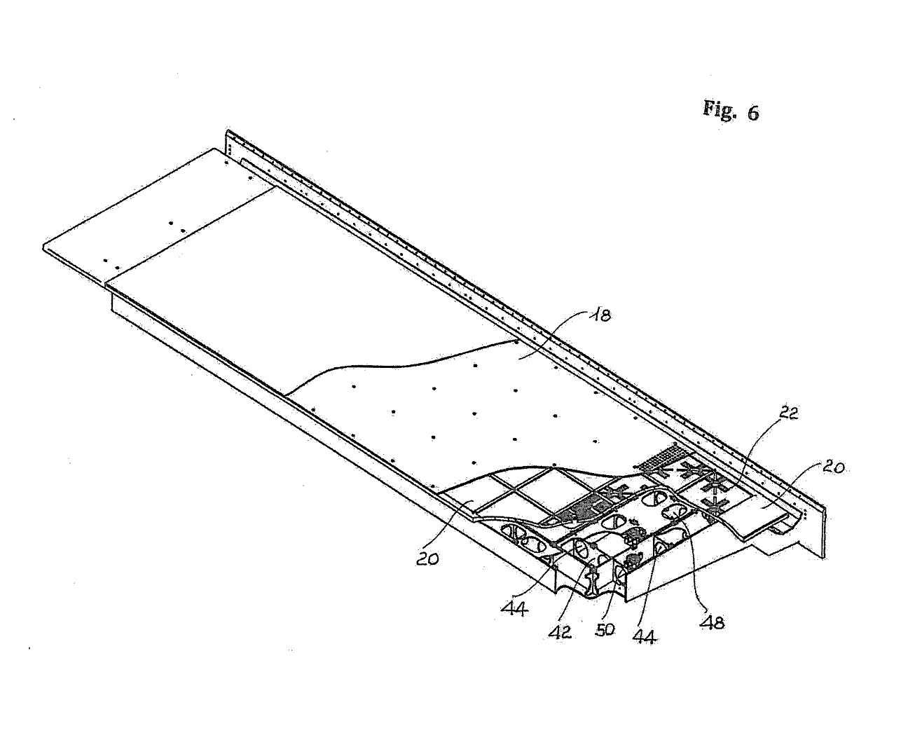

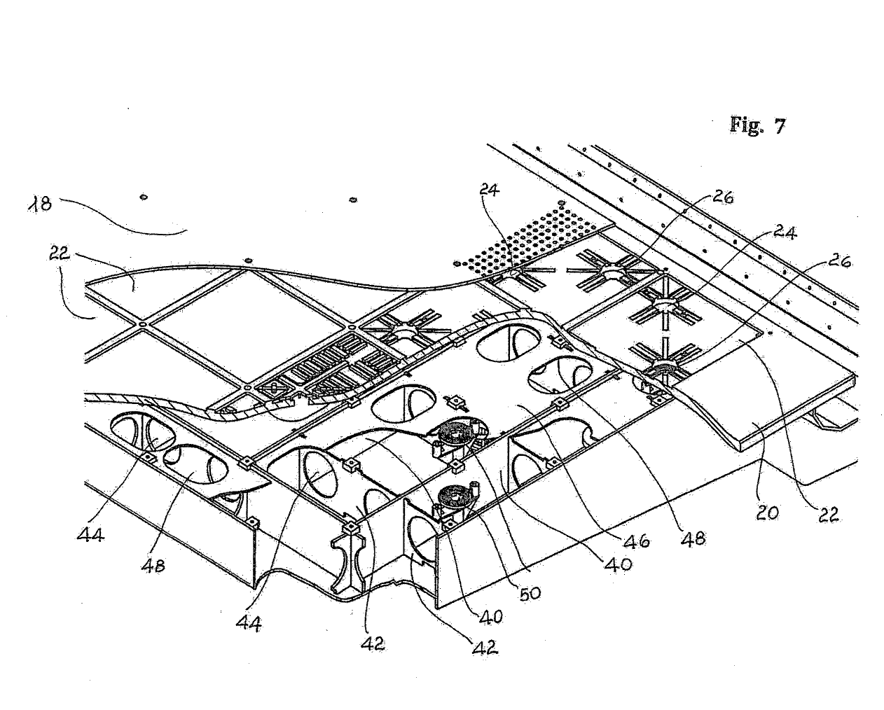

The exposed surface of the cutting table 10 is defined by a permeable cover, indicated by reference numeral 18 and visible in detail in FIGS. 5 and 6, formed of perforated material. The cover 18, of flexible, felt-type material, rests on an underlying rigid structure 20, the surface of which is provided with quadrangular indentations 22, corresponding to the sectors 12 schematically shown in FIG. 1. Each indentation 22 is provided with two apertures 24, 26 visible in FIGS. 6 and 7, the function of which will be specified below.

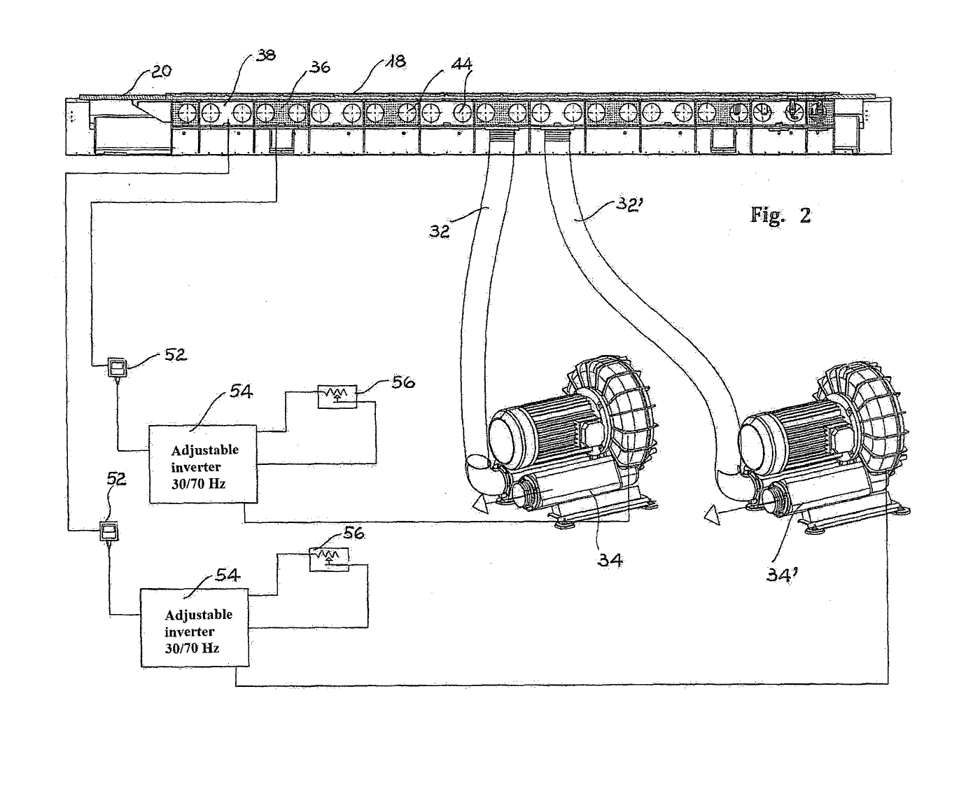

The cutting table 10 is substantially formed of a metal box, as may be seen for example in FIGS. 2, 6 and 7 wherein the rigid structure 20 constitutes the lid, surmounted by the cover 18.

The underlying structure of the cutting table 10, indicated by reference numeral 28, defines a container open at the top in which a multiplicity of seats are made, for example having a quadrangular layout, mainly of the same extension.

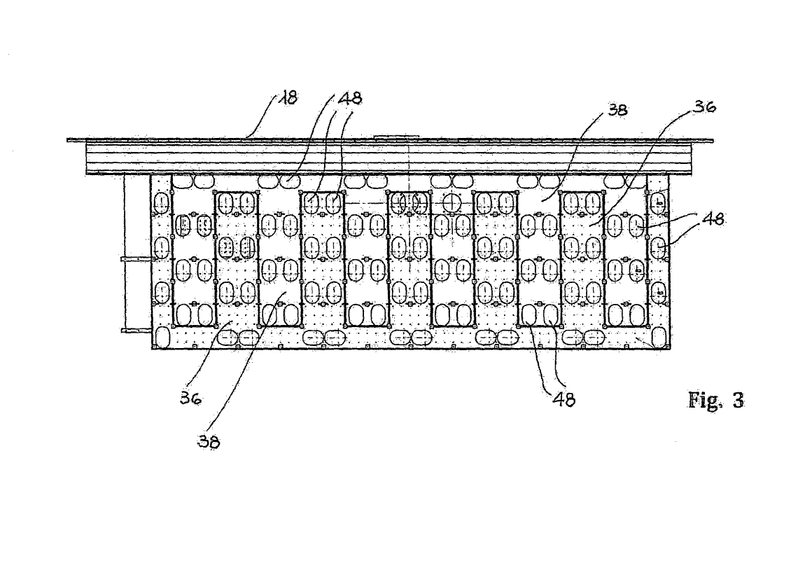

Said seats extend from a common base 30 of the structure 28 and form at least two independent grids, each of which is connected by a duct 32, 32′ to a suction pump turbine 34, 34′. Said at least two independent grids extend in a transversal direction along the table 10, as shown in FIG. 3 and form at least two compartments separate from each other.

The marked sections in FIG. 3 identify such compartments, respectively numbers 36 and 38, wherein the dotted compartment identifies, for example, the one connected to the pump 32 performing high pressure suction. The compartments 36 and 38 are formed of walls and septums extending in a transversal and longitudinal direction in the structure 28; said walls, some of which indicated by reference numeral 40 in FIG. 6, if necessary, are provided with apertures 44 which permit the passage of the suction air between the various parts of the individual compartments 36 and 38. The openings 44 are formed, in particular, along the septums 42 which are arranged orthogonally with respect to the walls 40 and stiffen the structure as a whole to give rise to said independent compartments 36 and 38. The division thus formed is such that in each of the sectors 12 a high pressure or low pressure suction may be alternately created, as specified below with reference to FIG. 5. Between the walls 40 alternating with the sectors 42 and the rigid structure 20 a plate 46 provided with holes 48 is advantageously arranged; these holes are created in correspondence with the openings 24 and 26 of the quadrangular indentations 22. FIG. 5 shows a square sector 12 in which the right, dotted half-side corresponds to the area with high suction pressure and the left half-side corresponds to the area with low suction pressure. Both suctions take place through the mouth 50 of the individual valve groups, placed at the holes 48 of the plate 46 and respectively communicating with the compartment 36 and with the compartment 38; in said compartments high and low pressure suction is respectively created thanks to the connection ducts 32 and 32′ with the suction pumps 32 and 32′.

At each of the compartments 36 and 38 a monitoring transducer 52 of the pressure combined with an inverter 54 and a potentiometer 56 suitable for the regulation of the suction induced by the pumps 32 and 32′ is placed.

During the operating step, the material 14 lies on the cutting table 10 divided into 12 square sectors and the individual shapes 16 to be cut are projected in a known manner on said surface. As shown in the example in FIG. 1, the material 14 does not cover all the square areas 12 so that suction is first carried out only in correspondence with the sectors 12 completely or partially covered by said material. Given the possibility of activating a high or low suction pressure, during the cutting of the shapes 16 a low pressure suction is first enabled by means of the pump 34′, so as to distend and stabilise the material 14 in a predefined manner When the cutting blade acts on the various shapes 16 instead, the high pressure suction is activated in relation to the sectors 12 in which the material 14 is subjected to cutting and possibly also to the adjoining sectors; in said sectors the suction is switched automatically, excluding the low pressure. If the cutting should involve significantly extensive parts, for example relative to the formation of coverings for seats or cushions of vehicles or upholstered items covering a large surface area of the cutting table, the high pressure suction may be limited to one or a few sectors 12, in the first place to the sector 12 directly affected by cutting and to that adjoining it on which said cutting will continue, and so on. This is so as to avoid or limit losses in efficacy of the suction effect, which could actually be appreciably reduced if they were to occur simultaneously along a large part of the cutting table. The detection of the sectors 12 affected by high pressure activation takes place subsequent to the so-called positioning, in which the software which manages the entire cutting operation recognises the areas, i.e. the sectors 12, in which the material is positioned and first determines the activation of the pump 34′ for low pressure suction bearing the relative valve groups 50 and, at the moment of cutting, the pump 34 and other valve groups 50 for the high pressure. The activation of the low/high pressure may also be performed manually, without using software, and as decided by the operator, who may thus decide, for some areas, to always have, for example, high pressure; this may happen with leather which in some places is not in sufficiently stable contact with the work surface.

This leads to a more effective stabilisation of the material 14, which remains localised to the parts affected by cutting and any adjoining areas chosen by the operator. The breathable or micro-perforated cover 18 placed on the work surface ensures adequate permeability, so that suction takes place at greater or lesser intensity on the material 14 on parts thereof depending on the high or low pressure.

After completing the cutting operation along a given area, the corresponding sector 12 no longer affected by cutting passes onto low pressure suction while the software activates the temporary high pressure suction along the sector or sectors 12 which the shapes 16 still to be cut lie on, unless set up otherwise by the operator for sectors or areas not affected by the cutting at that time; in the other areas, not yet cut and away from the cutting area low pressure remains.

It is understood that, with these operating modes, energy consumption is also optimised, since the pump 34′ for the low pressure suction is activated at a medium-low speed, but also the pump 34 for in high-pressure suction is not subjected to high speeds since such suction is localised.

Consequently, even the noise level is limited, to the benefit of operators in the vicinity of the cutting table.

As previously indicated, with the positioning software the division of the material 14 to be cut into the various shapes 16 is programmed; by means of the same or other collateral software the operational phases that activate the high/low pressure suction of the sectors 12 are advantageously handled, it being understood moreover that such activations may still be made by other means, for example optical and/or electromechanical as well as manually.

Despite the invention having been described above with particular reference to one of its embodiments, given solely by way of a non-limiting example, numerous modifications and variants will appear evident to a person skilled in the art in the light of the above description. The present invention therefore sets out to embrace all the modifications and variants which fall within the sphere and scope of the following claims.

1. A cutting table (10) with differentiated suction for stabilising the material (14) to be cut, comprising a surface having a planar extension divided into a plurality of sectors (12) and generally surmounted by a permeable cover (18) on which said material is laid, characterised in that said cover (18) rests on an underlying rigid structure (20) provided with indentations (22) corresponding to said sectors (12) along which two apertures are made (24-26) for the alternate suction of air at high and low pressure by means of respective pumps (34-34′), each of said sectors (12) being divided into two zones respectively used for high and low pressure suction by means of the intervention of specific valve groups (50).

2. The cutting table according to claim 1, characterised in that the cutting table comprises under the rigid structure (20), a structure (28) constituting a container open on the upper side in which a plurality of seats are made extending from the base (30) of said structure (28) and forming two independent compartments (36) and (38) each of which is connected, with a duct (32) or (32′), to said suction pumps (34) or (34′).

3. The cutting table according to claim 2, characterised in that the indentations (22) and the seats made on the upper side of the structure (28) are a quadrangular shape.

4. The cutting table according to claim 2, characterised in that said quadrangular layout seats formed in the structure (28) are defined by walls (40) and by septums (42) orthogonally positioned in relation to said walls, the septums (42) being provided with an opening (44).

5. The cutting table according to claim 3, characterised in that between the walls (40) with septums (42) and the rigid structure (20) a sheet (46) is positioned provided with holes (48) made in correspondence with the openings (24-26) of the indentations (22) created on said rigid structure (20).

6. The cutting table according to claim 1, characterised in that the part of the sectors (12) used for high pressure suction is activated during the cutting of the material (14) on which a plurality of templates (16) to be obtained is predefined.

7. The cutting table according to claim 6, characterised in that on the sectors (12) not affected by the cutting of templates (16) from the material (14) low pressure suction of the relative part of said sectors is performed.

8. The cutting table according to claim 1, characterised in that the cutting table comprises for each of the compartments (36) and (38) a monitoring transducer (52) of the pressure combined with an inverter (54) and a potentiometer (56) for the regulation of the suction induced by the pumps (32) and (32′).

9. The cutting table according to claim 1, characterised in that the activation steps of the sectors (12) as regards high/low pressure suction are controlled by software or other electromechanical and/or optical means and/or manually.
